(19) United States
(12) Patent Application Publication
(10) Pub. No.: US 2011/0022413 A1
(43) Pub. Date: Jan. 27, 2011

(54) SYSTEMS AND METHODS FOR MAINTAINING COMPREHENSIVE MEDICAL RECORDS

(75) Inventor: Joan MARKESSINI, Alexandria, VA (US)

Correspondence Address: TROUTMAN SANDERS LLP;5200 BANK OF AMERICA PLAZA, 600 PEACHTREE STREET, N.E., SUITE 5200, ATLANTA, GA, 30308-2216, US

(73) Assignee: Welltrek International, Alexandria, VA (US)

(21) Appl. No.: 12/752,575

(22) Filed: Apr. 1, 2010

Related U.S. Application Data
(60) Provisional application No. 61/228,725, filed on Jul. 27, 2009.

(51) Int. Cl. G06Q 50/00

(52) U.S. Cl. 705/3

(57) ABSTRACT

Comprehensive medical records systems and methods are disclosed. A medical records system can comprise a storage device for storing digital data relating to medical records. On the storage device a, a medical record can include information about health problems and episodes, particular medical events, encounters, interventions. Episodes may be tied together through unique identifiers to particular health problems or conditions, which in turn can tied together through unique identifiers to particular patients. Health information can be aggregated on the system to compose comprehensive, longitudinally ordered patient health profiles.

### CROSS-REFERENCE TO RELATED APPLICATION

This application claims a benefit, under 35 U.S.C. § 119(e), of U.S. Provisional Application Ser. No. 61/228,725, filed 27 Jul. 2009, the entire contents and substance of which are hereby incorporated by reference.

### TECHNICAL FIELD

Various embodiments of the present invention relate to electronic storage systems and, more particularly, to electronic systems for storing and maintaining medical records, as well as methods for providing same.

### BACKGROUND

For hundreds of years, each medical practitioner kept patient records in paper files maintained at his or her office. These paper records generally only included entries recorded at the office at which the record was kept. If a patient visited a different medical practitioner for any reason, records of that visit were maintained with the other practitioner. Accordingly, the medical records did not provide a comprehensive record of any patient's medical history. In order to supplement such records, medical practitioners generally relied upon each patient to report his or her medical history.

In the past several years, medical practitioners have been replacing their paper files with electronic files. However, these electronic files still suffer many of the same drawbacks as paper files because the electronic medical records are not shared between all of a patient's various medical service providers. Additionally, current electronic medical record software is generally designed for a specific category of medical service and does not provide capabilities for comprehensive records.

Additionally, many patient information systems, both paper based and electronic, focus on business issues rather than medical issues. For example, they may focus on admission, disposition, financial records, and insurance data. These systems are best used for keeping track of issues such as: (1) when the patient was admitted for evaluation and treatment; (2) when the patient was discharged; (3) who discharged the patient; (4) whether the patient, or a caretaker, family member, or insurance carrier, can pay for the services rendered; (5) how payment was made. Some of these record-keeping systems also address what happens to the patient following the medical intervention, such as a referral to another practitioner.

Existing clinical records for a given patient are often fragmented, scattered across the files and archives kept for multiple healthcare providers. This may be especially problematic when a given medical event requires the interaction of different medical disciplines. For example, pathology reports and images or radiological studies are usually filed within a separate department of a medical center and they may or may not be compiled with other pertinent health records. Further, these records may not even follow a patient from one operational unit to another within a given hospital. Intake information from an emergency room admission may or may not reach the floor of the medical center where the governing medical discipline for a particular medical event, and patient, are situated. Additionally, for substance regarding the clinical record, any diagnoses, studies related to those diagnoses, treatments received, and how the patient responded to such treated, a medical practitioner may need to search through various notes accumulated from various records from different healthcare practitioners. Additionally, these records may have been created at various times in various locations, making it difficult to create a comprehensive record. Accordingly, as it exists today, medical and healthcare recordkeeping is an inaccurate, redundant, messy, inefficient, arduous, and expensive process.

Accordingly, there is a need in the art for a system and method for maintaining comprehensive medical records.

Further, there is a need in the art for a system and method for sharing medical records between different medical facilities.

Additionally, there is a need in the art for a system and method for maintaining comprehensive medical records using a confidential secure system that prevents access by unapproved persons.

### SUMMARY

Various embodiments of the claimed invention are comprehensive medical records systems. In accordance with an exemplary embodiment, a medical records system is comprehensive, in that it is designed to encompass and incorporate substantially all possible patient health episodes, practitioner healthcare disciplines, and physiological and anatomical diagnostic studies into a single medical records system. The system preferably utilizes audio and full color, high-resolution still and motion video media. The system is longitudinal in so far as it may capture, in back-dated order, as much of a patient's health history as his or her existing records, knowledge, and/or memory permits.

The present invention may be distinguished from traditional record keeping systems through its focus upon the patient's health and medical history, emphasis upon health problems and episodes; comprehensiveness, longitudinal stance, multimedia dimensions, and security. With respect to its emphasis upon health problems and episodes, particular medical events, encounters, interventions, and episodes may be tied together through unique identifiers to particular health problems or conditions, which in turn are tied through unique identifiers to particular patients. These problems are aggregated to compose a comprehensive longitudinally ordered patient health profile.

The present invention may enable a healthcare practitioner to look back from the present as far back into the patient's life span as memory or available records permit as well as into the healthcare histories of the patient's family members where appropriate. Accordingly, the record may provide depth and breadth across numerous practitioners to a medical practitioner.

Exemplary embodiments of the medical records systems and methods may be implemented on computer hardware, computer software, or both. Accordingly, all or part of the medical records systems and methods may be embodied in computer-readable media and may be executable by one or more computer processing units.

### BRIEF DESCRIPTION OF THE APPENDICES

Appendix A is a manual for a medical records system, according to an exemplary embodiment of the present invention.

Appendix B illustrates various screenshots of the WELLTrek® medical records system, which is an embodiment of the medical records system implemented on a computing device, according to an exemplary embodiment of the present invention.

Appendix C describes testing of the WELLTrek® medical records system, according to an exemplary embodiment of the present invention.

### DETAILED DESCRIPTION

In an exemplary embodiment of the present invention, a comprehensive medical records system is provided. The system may allow entry of medical data spanning a wide cross-section of the medical establishment. In an exemplary embodiment of the present invention, the system incorporates numerous possible patient health episodes, practitioner healthcare disciplines, and physiological and anatomical diagnostic studies. Such capabilities allow comprehensive data entry for substantially all possible medical events.

Additionally, the system may allow data sharing between multiple facilities as well as multiple practitioners within a single facility. For example, and not limitation, the present invention may be used in a hospital to allow all medical personnel to enter data into a single medical records system. In such an embodiment, various departments, such as emergency, labor and delivery, surgical services, and radiology, may access the system to input data and to review records entered by other departments. Additionally, the system may allow medical personnel at other facilities to access the records.

The present invention may preferably contain a patient's entire medical history, or at least as much of the patient's history is available for entry. Once the present invention is implemented for a particular patient, all of that patient's future records may be maintained.

In accordance with an exemplary embodiment of the present invention, an electronic, comprehensive, multi-media, longitudinal patient health record and information management system is provided. The embodiment is comprehensive in that it is designed to encompass and incorporate substantially all possible patient health episodes, practitioner healthcare disciplines, and physiological and anatomical diagnostic studies into a single medical records system. The system preferably utilizes audio and full color, high-resolution still and motion video media. The system is longitudinal in so far as it may capture, in back-dated order, as much of a patient's health history as his or her existing records, knowledge, and/or memory permit.

The present invention is preferably encapsulated in software and may be designed to facilitate: (1) unambiguous identification of a patient for record and record retrieval; (2) recording of medical events and encounters with healthcare personnel; (3) capture, storage, and retrieval for review and transmission of diagnostic studies; (4) printing and/or transmission by various modalities of key elements of the record; and (5) database searching for specific patient records or for specific health related episodes.

The present invention may be distinguished from traditional record keeping systems through its focus upon the patient's health and medical history, emphasis upon health problems and episodes; comprehensiveness, longitudinal stance, multimedia dimensions, and security. With respect to its emphasis upon health problems and episodes, particular medical events, encounters, interventions, and episodes may be tied together through unique identifiers to particular health problems or conditions, which in turn are tied through unique identifiers to particular patients. These problems are aggregated to compose a comprehensive longitudinally ordered patient health profile. Additionally, aggregation of medical episodes may be automated.

Substantially all known health conditions of a patient, as well as all healthcare interventions from various healthcare disciplines known to have been engaged by the patient, may be captured and compiled using the present invention. Specifically, the present invention is not intended to be limited to any particular specialization of interest of a particular caretaker or medical facility. However, such specialized data may be captured or extracted for review and evaluation by a particular practitioner.

The present invention may enable a healthcare practitioner to look back from the present as far back into the patient's life span as memory or available records permit as well as into the healthcare histories of the patient's family members where appropriate. Accordingly, the record may provide depth and breadth across numerous practitioners to a medical practitioner.

The records may include text, graphics (such as an EKG trace), still-frame images, motion video clips (such as range of motion studies performed by an orthopedist), and audio records of speech (such as dictated clinical notes), and cardiovascular/pulmonary sounds.

The present invention may be highly secure and provide appropriate, secured entry and access by healthcare practitioners and administrators to pertinent patient data. Additionally, the present invention may limit data access to practitioners with predetermined characteristics. For example, certain private information may only be accessible to certain types of practitioners.

Various features of various embodiments of the present invention are provided below:

Because the nature of the healthcare received by any individual patient over the course of his or her life is episodic, this clinical record is organized episodically around specific medical problems.
Healthcare episodes are cumulated in an automated fashion and ranged against a time-line; the time-line is the patient's life span presented in reverse chronological order.
Particular medical encounters—patient visits, practitioner-to-practitioner consultations, and supporting diagnostic studies—and, related treatment regimens are keyed and bundled through a unique identifier to instantiate a particular health/medical episode.
Episodes are through these identifiers tied to particular health problems as determined by diagnostic codes, which in turn are tied through unique identifiers to particular patients, to compose a patient history.
The Patient Record Cumulates in Backdated Order Patient Episodes Detailed by Encounters and Grouped by Patient Presenting Health Problem

Always Comprehensive
Encompasses and incorporates all possible patient medical episodes, practitioner healthcare disciplines, and diagnostic studies
All known interventions from as many medical disciplines known to have been engaged by the patient are captured
not just the specializations of interest to a particular caretaker or medical facility.
The patient record thus provides depth and breadth across numerous practitioners for a single healthcare practitioner about a particular patient.

Secure, Multi-Media Data Entry
Video, Audio, and Text
   Full color, high-resolution still-frame images
   Motion video
   Speech
      Voice-over commentary
      Dictated clinical notes
   Cardiovascular/pulmonary sounds
Secure
   The record allows appropriate, secured entry and access by medical practitioners and administrators to pertinent patient alphanumeric and media data.

Some Specifications
WELLTrek clinical record is organized into Three Key Elements of the Record
   Patient Identification/Demographics/the Patient Data Form
      Unambiguous Identification
      Demographic Data for patient population analysis and reporting
   The Medical Encounter Record, with information grouped into these categories; and,
      The Presenting Problem with patient vital signs, alerts, signs and symptoms
      Encounters and Consultations
      Diagnostic Studies
      Treatments
   Patient Histories—Patient History, Problem History, Family History
The software program for WELLTrek is designed to facilitate:
   Unambiguous identification of a patient for record
   Recording of medical events and encounters
   Capture, storage, retrieval for review, and transmission of diagnostic studies
   Printing and/or transmission of key elements of record
   Accessing and exiting the recordkeeping system, and
   Search of a patient record database.
It offers a user-friendly single point of interface.
Diagnoses—preliminary through definitive—linked to a look-up table, Diagnoses, that contains an embedded ICD—Edition 10
HL—7 Compliant
Point-and-Click Mouse interface, including single-, double-, and right clicking, left-right scrolling, and up-down tabbing
300 Data-entry Fields of three types—color coded
   Gray—For data that pre-fills by automated forwarding and cross-linked fields
   Blue—For data that can be entered via a point-and-click interface and drop-down look-up tables
   White—For data that must be keyed in
Text Boxes for Open entry of Clinical Notes
For Treatment Plan Segment—Drug/Food interactions, Precautions, Common Side-effects are cross-linked fields
Automated, cumulated, life-span arrayed

Who Benefits Most from Its Use?
Attending/Primary care Physicians (Complete History)
Physician-specialists (Problem History/Problem History Report)
Small Group Practices
Patients

The success of any attempt to formalize, standardize, and preserve medical information is contingent upon the willingness of healthcare providers and practitioners to be disciplined and held accountable by an electronic medical record.

WELLTrek® EMR patient information management system helps the medical practitioner:
Compile, organize, and make sense of the data that may be available about a given patient or set of patients or case load
Quickly enter accurate in-depth portraits of the health and well-being of given patients
Permanently retain those records
Rapid search of the data base enables identification of, for example, whether or not a chronic medical condition is endemic to a patient sample or population.

Other objects, features, and advantages of the present invention will become apparent upon reading Appendices A-C.

While various exemplary embodiments of medical records systems of the present invention are disclosed herein, many modifications, additions, and deletions can be made to the medical records systems without departing from the spirit and scope of the present invention and its equivalents.

What is claimed is:

1. A method of managing medical records, the method comprising:
receiving medical information relating to a first individual;
associating a unique identifier with the first individual;
conducting an automated process of organizing the medical information into reverse chronological order, using a computer processor;
associating a unique identifier with each of two or more healthcare episodes identified in the medical information;
linking the medical information with other medical information relating to a family member of the first individual; and
sharing the medical information between two or more medical practitioners or medical facilities.
